(19) United States
(12) Patent Application Publication
(10) Pub. No.: US 2022/0405281 A1
(43) Pub. Date: Dec. 22, 2022

(54) VERSATILE QUERY LOGIC ON DATA FLUX REVERSE ANALYZER

(71) Applicant: Bank of America Corporation, Charlotte, NC (US)

(72) Inventors: Manoj Kumar Govindan, Sabapathy Nagar (IN); Arvindh Vemati, Chitlapakkam (IN); Jeyadevi Rajasekarun, Selaiyur (IN); Rajkumar Selvam, Thekkeparambil (IN); Mahesh Subramanian, Vengaivasal (IN); John Dinakar Iruvanti, Yellandu (IN)

(21) Appl. No.: 17/351,476

(22) Filed: Jun. 18, 2021

(51) Int. Cl. G06F 16/2453; G06F 16/25; G06F 16/242; G06N 20/00

(52) U.S. Cl. CPC G06F 16/24535; G06F 16/254; G06F 16/243; G06N 20/00

(57) ABSTRACT

Data warehousing solutions utilize lengthy and complex SQL instructions. These SQL instructions are difficult to parse and understand underlying logic/transformations performed. Conventionally, extensive analysis, time and effort needs to be spent to understand such SQL instructions and detect any data abnormalities in the SQL instructions. This technical challenge is exacerbated in high-volume production systems that include multiple systems that each utilize their own sets of SQL instructions. Apparatus and methods described herein take as input a natural language inquiry received from a user. The system attempts to parse the natural language inquiry to identify one or more relevant SQL instructions. Apparatus and methods may utilize AI and natural language processing to locate relevant SQL instructions, deconstruct them into subqueries and map a logical operational flow. Based on the mapped logic flow, a natural language response may be formulated to the user inquiry.

### FIELD OF TECHNOLOGY

Aspects of this disclosure relate to detection and rehabilitation of data abnormalities in scripted database operations formulated using structured query language (“SQL”).

### BACKGROUND

Today, businesses generate large amount of electronic data. Many businesses have attained digitalization and operate electronically. However, to be useful, electronic data needs to be organized and searchable. Businesses have therefore deployed data warehousing solutions to store and organize their electronic data.

A data warehouse may include a computer system that stores data from operational databases and external sources. The data warehouse may include central repositories of integrated data from one or more disparate sources. The data warehouse may store current and historical data in one location (e.g., a data lake). The data warehouse may be used for creating analytical reports or generating other business intelligence based on information extracted from the data lake or other data repository.

Electronic data stored in a data warehouse is typically uploaded from operational systems (e.g., marketing or sales). The data may be “scrubbed” to ensure information added to the data warehouse meets a threshold quality level. The scrubbing may apply standardized data formatting to data received from different sources. Using a standardized data format may reduce data interpretation errors and improve reporting accuracy.

Data warehousing solutions typically include lengthy and intricate SQL instructions. These complex SQL instructions may perform extract, transform, load (“ETL”) operations on information stored in the data warehouse. The ETL operations may be used to generate analysis reports or other business intelligence based on the information stored in the data warehouse. Such SQL instructions may be difficult, if not impossible, for humans to understand accurately, precisely and consistently.

Humans cannot accurately and precisely map underlying logic/transformations triggered by a complex SQL instruction. Furthermore, humans are unable to reliably detect data abnormalities in complex SQL instructions. For example, a simple question such as why an employee report (generated by a SQL instruction) omits employees stationed in a target location may not be easy for a human to answer. Firstly, it is difficult for the human to identify relevant SQL instructions used to generate the employee report. Second, it is difficult for humans to understand operational and logical flow of any SQL instruction. Compounding this challenge, is that data warehousing solutions typically deploy multiple complex SQL instructions to generate even a single report.

It is therefore desirable to provide computational tools that accurately and precisely decipher complex SQL instructions. Preferably, the computational tools predict and map how data gets transformed/filtered as it moves through a data warehousing operational pipeline. It is also desirable to provide computational tools for generating human-understandable explanations of logical conclusions or detecting data abnormalities within complex SQL instructions.

Accordingly, it is desirable to provide apparatus and methods for a VERSATILE QUERY LOGIC ON DATA FLUX REVERSE ANALYZER which provides technical solutions for accurately and precisely deciphering complex SQL instructions.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows components of an illustrative system in accordance with principles of this disclosure;

FIG. 2 shows an illustrative process in accordance with principles of this disclosure;

FIG. 3 shows illustrative intermediate results generated in accordance with principles of this disclosure;

FIG. 4 shows illustrative intermediate results generated in accordance with principles of this disclosure; and

FIG. 5 shows a system in accordance with principles of this disclosure.

### DETAILED DESCRIPTION OF THE DISCLOSURE

Apparatus and method for VERSATILE QUERY LOGIC ON DATA FLUX REVERSE ANALYZER are provided. Methods may include an artificial intelligence (“AI”) method for responding to a user inquiry regarding a resultant dataset. The resultant dataset may be machine-generated by an operational string. The operational string may include SQL instructions. The SQL instructions may be executed against information stored in a data lake. The programmed operational string may execute an extraction, transfer load (“ETL”) operation. An ETL operation may input information into, or extract information from, the data lake.

A data lake may be a single storage location for all enterprise data. The enterprise data may include raw copies of source system data. The enterprise data may also include transformed data used for reporting, visualization, advanced analytics and machine learning. A data lake may store structured data, semistructured data and binary data. Structured data may include row and column data retrieved from relational databases. Semistructured data may include comma separated value (“CSV”) files, log files, extensible markup language (“XML”) files and java script object notation (“JSON”) files. Binary data may include image files, audio files and audio-visual files.

The method may include ingesting the user inquiry. The user inquiry may be formulated in a natural language form. “Natural language” may include language that is the ordinary, native speech of people. Methods may include ingesting the user inquiry in its natural language form. Methods may include parsing the user inquiry submitted in the natural language form and extracting a reference to the resultant dataset from within the user inquiry. The reference may include a column name, a table name, a report on which the user has a query or other keywords identified within the user inquiry.

Methods may include pinpointing a target SQL query that operates on the extracted reference. The target SQL query may include one or more SQL queries utilized to generate a report or other resultant dataset referenced in the user inquiry. A target SQL query may be alternatively referred to herein as a “relevant SQL instruction.”

The target SQL query may be located within ETL pipelines or workflows used to add or extract information from a data warehouse or data lake. A reference to the resultant dataset identified in the user inquiry may be determined based on establishing a logical link between a natural language term in the user inquiry and a machine understandable term in the target SQL query.

Methods may include mapping a natural language contextual description of the reference in the user inquiry to a target SQL operator within the target SQL query. For example, methods may include determining that the user inquiry includes a question regarding why a target report does or does not include particular records. The user inquiry may describe the particular records as being earlier or later than a date. The user inquiry may describe the particular records as being greater or less than a value. The user inquiry may describe the particular records as being included or excluded from a category.

Methods may include locating a contextual description that describes, in natural language, why the user inquiry is being submitted. Methods may include mapping the contextual description to a target SQL operator within the target SQL query. For example, methods may include determining that the user inquiry includes a question why a report does not include records after a target date. In this example, methods may include mapping the contextual description (e.g., records after target date) to a greater than (“>”) or less than (“<”) operator within a target SQL query that is utilized to generate the report referenced in the user inquiry.

Methods may include recursively deconstructing the target SQL query. The target SQL query may be deconstructed into a plurality of subqueries. Each subquery may be defined by including at one target SQL operator and at least one driver table. The driver table may be an input to the target SQL operator. The at least one driver table may be the resultant dataset.

Methods may include generating a natural language description of each subquery. Methods may include applying a machine learning filter to the generated subqueries. The machine learning filter may identify a target subquery. The target subquery may link the resultant dataset to a target SQL operator extracted from the user inquiry.

For example, the target subquery may perform an operation that removes records from a dataset. The resultant dataset may therefore omit the removed records. Methods may include formulating a machine generated, natural language response to the user inquiry. The response may include a natural language description of the target subquery and the associated link to the resultant dataset.

The machine generated, natural language response to the user inquiry may explain, in natural language, why operation of the target subquery generates the resultant dataset presented to the user. A natural language description of the target subquery may be included in the response provided to the user inquiry. For example, the natural language description of the target subquery may explain that because records are removed during execution of the underlying target SQL query, therefore, the resultant dataset does not include those particular records.

In some embodiments, the removal of the records by the target SQL query may be identified as an error in the target SQL query. Methods may include curing the error by generating a revised target SQL query. The revised SQL query may be generated such that the resultant dataset includes records identified in the user inquiry. Methods may include determining whether revising the target SQL query impacts other segments of the target SQL query.

For example, altering a target subquery of the target SQL query to include or exclude particular records may impact operation of other segments of the larger target SQL query. Other segments of the target SQL query may expect a set of records to be available in an intermediate dataset generated by the target subquery. Alternatively, other components of the target SQL query may not expect a set of records to be present in an intermediate dataset generated by the target subquery. Methods may include examining other segments of the target SQL query before changing the target subquery.

When the machine learning filter fails to identify the target subquery, methods may include triggering automated testing of each of the plurality of subqueries. The automated testing of each of the subqueries may attempt to identify a subquery that affects data records extracted from the user inquiry. The automated testing may attempt to locate a subquery that affects the reference or resultant dataset extracted from the user inquiry.

Methods may include formulating a machine-generated alternative SQL query. The alternative SQL query may be responsive to the user inquiry. For example, the alternative SQL query may delete or change a target subquery included in the target SQL query. Methods may include testing any generated alternative SQL queries. The testing may verify that the machine-generated alternative SQL query is responsive to the user inquiry. The testing may determine whether the alternative SQL query generates a resultant dataset that is aligned with a logical premise or conclusion of the user inquiry. Methods may include formulating a machine generated, natural language response to the user inquiry based on the machine generated alternative SQL query.

For example, a user inquiry may include a question why records are omitted from a resultant dataset. A machine-generated alternative SQL query may generate a report that includes the records flagged in the user inquiry as being “omitted.” The natural language response provided to the user inquiry may describe the functionality and logic flow of the machine-generated alternative SQL query.

An artificial intelligence (“AI”) detector of a data abnormality in output generated by a SQL query is provided. The SQL query may execute in a high-volume computer system. A high-volume computer system may process data containing increasing variety, in increasing volume and with increasing velocity. Volume may range from terabytes to hundreds of petabytes or more. Velocity is a rate at which data is received and processed by the computer system. For example, the computer system may run applications that receive millions of new records each day and require real-time results. Variety includes processing of unstructured, semistructured data types such as text, audio and video.

The AI detector may include a computer processor. The AI detector may include one or more non-transitory computer-readable media storing computer executable instructions. The computer executable instructions, when executed by the computer processor may detect SQL functionality and logic flow.

The AI detector may ingest, in a natural language form, a user inquiry regarding the output generated by the high-volume computer system. The AI detector may extract a resultant dataset from the user inquiry. The AI detector may establish a logical link between the resultant dataset and a target SQL query.

The AI detector may deconstruct the target SQL query into a plurality of subqueries. The AI detector may locate multiple target SQL queries and deconstruct each of the target SQL queries. Each subquery may be a “unit of interest.” Each “unit of interest” may be executable as a stand-alone SQL query. Each subquery may be executable as a stand-alone SQL query. A stand-alone SQL query may include at least one SQL operator and operand pair.

The AI detector may validate that each subquery is properly formatted and does not include syntax errors. The AI detector may validate that each subquery impacts formulation of the resultant dataset. The AI detector may validate a subquery by executing the subquery. The AI detector may generate sample data that may be used when validating the subquery.

The AI detector may create a set of subqueries. The AI detector may add a subquery to the set when the AI detector determines that the subquery impacts formulation of the resultant dataset referenced in the user inquiry. The AI detector may determine that a subquery impacts formulation of the resultant dataset based on executing or simulating execution of a subquery.

Using the set of subqueries, the AI detector may construct a machine-generated resultant SQL query. The resultant SQL query, when executed by the high-volume computer system, may formulate the resultant dataset. The AI detector may extract, from the user inquiry, a contextual description of the resultant dataset. The contextual description may map onto a target SQL operator. The AI detector may determine whether the machine-generated resultant SQL query includes the target SQL operator.

The AI detector may convert, into natural language form, each subquery included in the resultant SQL query and includes the target SQL operator. The AI detector may construct a natural language response to the user inquiry. The AI detector may construct the natural language response using one or more subqueries that have been converted into natural language form. Each subquery that has been converted into natural language form may include at least one operator that maps onto a contextual description included in the user inquiry.

The AI detector may determine whether the machine-generated resultant SQL query includes a variant SQL operator that generates the same result as the target SQL operator. The AI detector may convert each subquery within the resultant SQL query that includes the variant SQL operator into natural language form. A variant SQL operator may be an operator that is logically equivalent to the target SQL operator. A logically equivalent operator may include one or more mathematical functions that, when executed sequentially, provide the same result as the target SQL operator.

Logical equivalence may be determined based on generating a mathematical formula corresponding to the target SQL operator. The AI detector may search for one or a combination of SQL operators within the resultant SQL query that collectively, are mathematically equivalent to the target SQL operator.

The AI detector may validate that each subquery impacts formulation of the resultant dataset by changing at least one SQL operator included in each subquery. After changing the at least one SQL operator, the AI detector may determine whether, after the changing, the resultant SQL query generates the resultant dataset.

The AI detector may trigger automated retraining of a machine learning model that maps one or more SQL operands into natural language phrases. The AI detector may trigger the retraining when the AI detector is unable to extract a contextual description of the resultant dataset that maps onto a target SQL operator. The AI detector may trigger automated retraining of the machine learning model when the AI detector is unable to identify a resultant dataset in the user inquiry.

The AI detector may validate that each subquery impacts formulation of the resultant dataset. The AI detector may determine whether a subquery impacts formulation of the resultant dataset by providing modified values for at least one operand referenced in the subquery. An illustrative operand may include a data column, a data row or data in cell of a table. When the resultant dataset changes in response to the modified values, the AI detector may conclude that the subquery impacts formulation of the resultant dataset.

When the resultant dataset does not change in response to the modified values, the AI detector may ignore the subquery. Because the resultant dataset does not change in response to the modified value, the AI detector may determine that the subquery does not impact the issue raised in the user inquiry with respect to the resultant dataset. Ignoring subqueries may save processing time and power that would have otherwise been consumed to generate, validate or test a resultant SQL query that includes the irrelevant subqueries.

An artificial intelligence (“AI”) detector is provided. The AI detector may provide autonomous identification and remediation of a data abnormality in a resultant dataset generated by a SQL query executed in a high-volume computer system. The AI detector may include a computer processor. The AI detector may include one or more non-transitory computer-readable media storing computer executable instructions. The computer executable instructions, when executed by the computer processor may implement functionality of the AI detector.

The AI detector may ingest, in a natural language form, a user inquiry regarding output generated by the high-volume computer system. The AI detector may extract the resultant dataset from the user inquiry. The AI detector may establish a logical link between the resultant dataset and a target SQL query. The AI detector may deconstruct the target SQL query into a plurality of subqueries. The AI detector may validate that each subquery is executable and impacts formulation of the resultant dataset.

The AI detector may create a set of subqueries. Each member of the set may impact formulation of the resultant dataset. The AI detector may convert each member of the set of subqueries into a natural language form. The AI detector may apply a natural language processing algorithm and detect terms associated with an overlapping interest shared by the natural language conversion of the subqueries and the natural language user inquiry.

The AI detector may determine whether the natural language terms associated with the overlapping interest are aligned or misaligned. An aligned term may generate an intermediate result that is in accordance with an expectation of the user. A misaligned term may generate an intermediate result that deviates from an expectation of the user. An expectation of the user may be determined based on a machine generated understanding of the natural language user inquiry. The AI detector may apply natural language processing that compares natural language terminology in the user inquiry to the natural language conversion of the subqueries. Based on the comparison, the AI detector may determine whether a subquery is aligned or misaligned.

For example, a user inquiry may ask “why xyz record is not present in report 1.” The AI detector may locate subqueries that include natural language terms that describe removing records having one or more attributes in common with xyz record. Such subqueries may be considered “misaligned.” The AI detector may locate subqueries that include natural language descriptive terms that have no impact (inclusion or exclusion) on records having one or more attributes in common with xyz record. Such subqueries may be considered “aligned.” The AI detector may locate subqueries that generate intermediate datasets that include records having one or more attributes in common with xyz record. Such subqueries may also be considered “aligned.”

For each misaligned term, the AI detector may locate the corresponding SQL subquery that was converted into the misaligned term or description. The AI detector may reformulate the corresponding SQL subquery so that it generates a natural language description that is aligned with the user inquiry.

The AI detector may utilize natural language processing algorithms such as Levenshtein distance algorithms to detect natural language terms associated with the overlapping interest. The AI detector may use natural language processing algorithms such as word tokenization to detect natural language terms associated with the overlapping interest. The AI detector may generate a step-by-step natural language explanation of how and why a target SQL query generates the resultant dataset. The natural language explanation may be provided to a user as a response to the user inquiry.

Apparatus and methods in accordance with this disclosure will now be described in connection with the figures, which form a part hereof. The figures show illustrative features of apparatus and method steps in accordance with the principles of this disclosure. It is to be understood that other embodiments may be utilized, and that structural, functional and procedural modifications may be made without departing from the scope and spirit of the present disclosure.

The steps of methods may be performed in an order other than the order shown and/or described herein. Method embodiments may omit steps shown and/or described in connection with illustrative methods. Method embodiments may include steps that are neither shown nor described in connection with illustrative methods. Illustrative method steps may be combined. For example, an illustrative method may include steps shown in connection with any other illustrative method.

Apparatus may omit features shown and/or described in connection with illustrative apparatus. Apparatus embodiments may include features that are neither shown nor described in connection with illustrative apparatus. Features of illustrative apparatus may be combined. For example, an illustrative apparatus embodiment may include features shown or described in connection with any other illustrative apparatus and/or method embodiment.

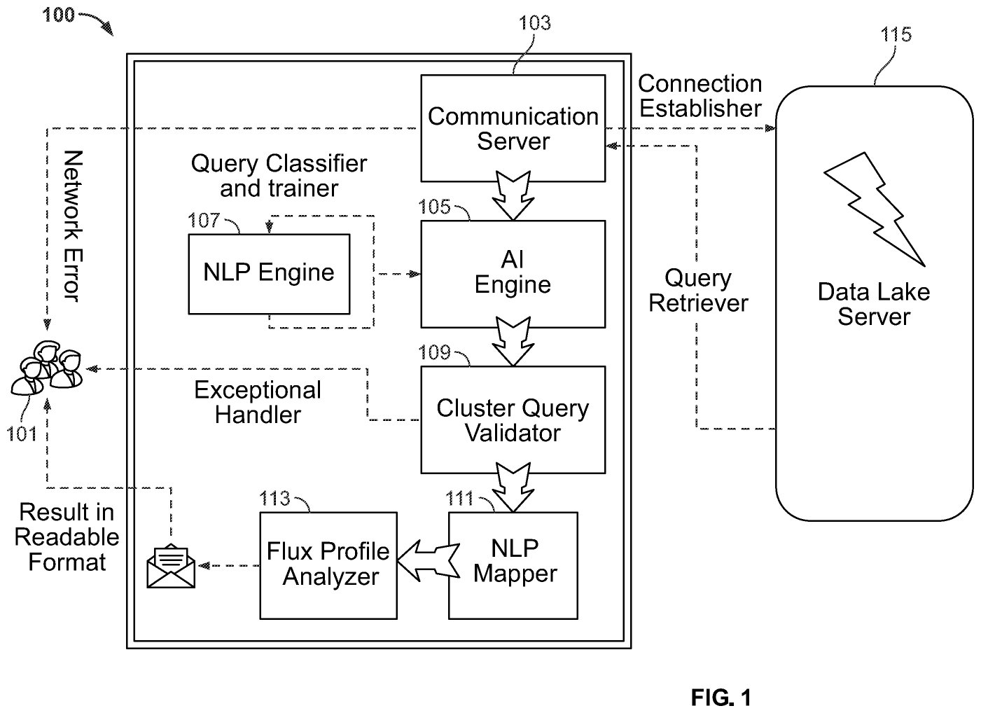

FIG. 1 shows illustrative system 100. System 100 may include one or more computer systems. An illustrative computer system may include a processor circuit. The processor circuit may control overall operation of a computer server. A processor circuit may include hardware, such as one or more integrated circuits that form a chipset. The hardware may include digital or analog logic circuitry configured to perform any suitable (e.g., logical) operation.

The computer system may include one or more of the following hardware components: I/O circuitry, which may include a transmitter device and a receiver device and may interface with fiber optic cable, coaxial cable, telephone lines, wireless devices, physical network layer hardware, a keypad/display control device or any other suitable encoded media or devices; peripheral devices, which may include counter timers, real-time timers, power-on reset generators or any other suitable peripheral devices; a logical processing device, which may compute data structural information, structural parameters of the data, quantify indices; and machine-readable memory.

The computer system may include RAM, ROM, an input/output (“I/O”) module and a non-transitory or non-volatile memory. Machine-readable memory may be configured to store information in machine-readable data structures. The I/O module may include a microphone, button and/or touch screen which may accept user-provided input. The I/O module may include one or more of a speaker for providing audio output and a video display for providing textual, audiovisual and/or graphical output.

Software applications executed by the computer system may be stored within the non-transitory memory and/or other storage medium. Software applications may provide instructions to the processor that enable the computer system to perform various functions. For example, the non-transitory memory may store software applications used by an AI engine or natural language processing engine, such as an operating system, application programs, machine learning models and an associated database. Alternatively, some or all of computer executable instructions of a software application may be embodied in hardware or firmware components of a computer system or server.

Software applications may include computer executable instructions for invoking user functionality related to communication, such as email, short message service (“SMS”), and voice input and speech recognition applications. Software application programs may utilize one or more algorithms that process received executable instructions, perform power management routines or other suitable tasks.

Software applications may utilize computer-executable instructions, such as program modules, executed by a processor. Generally, program modules include routines, programs, objects, components, data structures, etc. that perform particular tasks or implement particular abstract data types. A computer system may be operational with distributed computing environments where tasks are performed by remote processing devices that are linked through a communications network. In a distributed computing environment, program modules may be located in both local and remote computer storage media including memory storage devices. Computer systems may rely on a network of remote servers hosted on the Internet to store, manage, and process data (e.g., “cloud computing” and/or “fog computing”).

A computer system may be part of two or more networks. A computer system may support establishing network connections to one or more remote computer systems. Illustrative network connections may include a local area network (“LAN”) and a wide area network (“WAN”). When used in a LAN networking environment, a computer system may be connected to the LAN through a network interface or adapter. A computer system may include a communication circuit. The communication circuit may include a network interface card or adapter.

When used in a WAN networking environment, a computer system may include a modem, antenna or other circuitry for establishing communications over a WAN, such as the Internet. The communication circuit may include a modem and/or antenna.

The existence of any of various well-known protocols such as TCP/IP, Ethernet, FTP, HTTP and the like is presumed, and a computer system may be operated in a client-server configuration to permit a user to retrieve web pages from a web-based server. Web browsers can be used to display and manipulate data on web pages.

A computer system may include components, such as a display, battery, speaker, and antennas. Components of a computer system may be linked by a system bus, wirelessly or by other suitable interconnections. Components of a computer system may be present on one or more circuit boards. In some embodiments, the components may be integrated into a single chip. The chip may be silicon-based.

User 101 of system 100 may submit an inquiry to communication server 103. The user inquiry may include a natural language question regarding a resultant dataset. For example, the resultant dataset may be a report generated by extracting information from a data lake or other repository of information. The resultant dataset may be formulated by a lengthy and complex SQL query that identifies data stored in repository 115 and extracts specific data for inclusion in the resultant dataset.

The inquiry received from user 101 may include a natural language question regarding why the resultant dataset includes or excludes specific informational elements or categories of data elements. For example, the resultant dataset may be an employee report. The user inquiry may question why the employee report does not list employees that reside in a particular town or county. Conventionally, determining the answer to this user inquiry is technically difficult.

SQL instructions (e.g., one or more SQL queries) that generate the employee report may perform extract, transform, load (“ETL”) operations on multiple tables of information stored in a data repository (e.g., warehouse or lake) to generate the report. Such SQL instructions are difficult, if not impossible, for humans to understand. Furthermore, even if a human were able to understand the logical flow of the SQL instructions, extensive analysis would be required to determine whether there are any flaws in the logic executed by the SQL instructions or data abnormalities generated by the SQL instructions.

System 100 provides computational tools that ingest the user inquiry in natural language form. System 100 determines the logical segments of SQL instructions that are relevant to the question posed in the user inquiry. System 100 provides automated tools for validating target segments of the logical SQL segments. System 100 provides automated tools for formulating a response to the user inquiry based on relevant segments of the SQL instructions. System 100 may formulate the response in natural language form and provide the response to User 101. In some embodiments, system 100 may correct any detected flaws in a logic flow or data abnormalities in segments of relevant SQL instructions.

Communication server 103 may receive the inquiry from User 101. Communication server 103 may utilize AI engine 105 to decipher natural language elements of the received user inquiry. AI engine 105 may utilize natural language processing (“NLP”) engine 107. NLP engine 107 may identify keywords within the user inquiry. Each identified keyword may define an “area of interest.” Illustrative areas of interest may include a column name, a table name, or a reference to the resultant dataset that is the subject of the user inquiry.

AI engine 105 may utilize the keywords and areas of interest to locate relevant SQL instructions stored in repository 115. AI engine 105 may extract key words from the user inquiry. AI engine 105 may utilize NLP engine 107 to locate column name, table name, the report on which the user has a query or other SQL language that corresponds to the natural language of the user inquiry.

AI engine 105 may attempt to locate relevant SQL instructions that are executed to generate the resultant dataset. AI engine 105 may deconstruct the relevant SQL instructions into subqueries. Each subquery may be independently executable as an independent SQL instruction. For example, each subquery may include at least one operator and at least one operand.

AI engine 105 may perform the following steps to deconstruct the relevant SQL instructions into subqueries:

Step 1: AI engine 105 scans the relevant SQL instructions for a first keyword. An illustrative keyword may include the first “from” keyword in the SQL instructions. In the family of SQL languages, conventionally the word after “from” is a driver table for the SQL instructions. In SQL instructions, data (rows and/or columns) from the driver table will be joined to other tables referenced in the SQL instructions. If AI engine 105 is unable to locate the driver table at this step, another attempt will be made at step 6, discussed below.

Step 2: AI engine 105 marks each opening parenthesis “(” in the relevant SQL instructions with an identifier fₙ where subscript n is a variable representing the n^{th} occurrence of an opening parenthesis within the relevant SQL instructions.

Step 3: AI engine 105 marks each closing parenthesis “)” in the relevant SQL instructions with an identifier gₙ where n is a variable representing the n^{th} occurrence of a closing parenthesis within the relevant SQL instructions.

Step 4: Once steps 2 and 3 are complete, check whether the n value for fₙ and gₙ is identical. A deviation in the n value may represent a syntax or logic error in the relevant SQL instructions.

Step 5: Map each instance of fₙ to a corresponding instance of gₙ. AI engine 105 may perform the mapping by order of decreasing values of n for each gₙ. For example, the relevant SQL instructions may include four instances of fₙ (e.g., f₁, f₂, f₃, f₄) and four instances of gₙ (e.g., g₁, g₂, g₃, g₄). In this scenario, AI engine 105 generates the following mappings:
f₁ to g₄
f₂ to g₃
f₃ to g₃
f₄ to g₁

Step 6: If AI engine 105 was unable to locate a driver table at step 1, AI engine 105 may repeat step 1 for each fₙgₙ pair till driver table is found.

Step 7: Starting from the innermost mapping i.e., fₘₐₓ₍ₙ₎, AI engine 105 detects keywords such as “join,” “where,” or “group by” within the relevant SQL instructions. AI engine 105 may assign each detected keyword an identifier K_{n,i} where n is the fₙ mapping number and i is the i^{th} occurrence of a detected keyword. For example, a second keyword identified within mapping f₁ is given the identifier K_{1,2}.

Step 8: If a “join” operator is present in the relevant SQL instructions, AI engine 105 may assign a K_{n,i} identifier along with the joined column. The joined column may itself be a complex SQL instruction that may be deconstructed into subqueries. The assigned K_{n,i} identifier may represent the macro joined columnar instruction and subsequent K_{n,i} identifiers may represent individual subqueries that comprise the macro columnar instruction.

Step 9: Once all K_{n,i} are identified across all mappings, AI engine 105 may split each fₙgₙ mapping into separate hierarchies with each K_{n,i} identifier forming a connecting node between hierarchies wherever applicable.

In some embodiments, AI engine 105 may analyze the fₙgₙ mappings determined at step 5 and attempt to locate “areas of interest” within the mappings. Areas of interest may represent subqueries likely to be relevant to a question raised in the user inquiry. Locating an area of interest may include the following steps:

Sub-step a: Remove keywords such as “select,” “from,” “join,” special characters, and arithmetic operators from a subquery. Removal of the keywords may leave only the operands or column names.

Sub-step b: Apply NLP engine 107 to column names to group them into categories. NLP engine 107 may utilize illustrative algorithms such as Levenshtein distance and word tokenization.

Sub-step c: AI engine 105 may align column names with alias names of corresponding source tables. A SQL instruction may operate on multiple columns that each share an identical name. For example, a relevant SQL instruction may operate on multiple tables that each include a column extracted from another table. To differentiate between source tables that may each include an identical column, AI engine 105 may associate each column name with the source table name or other alias representing the source table. In an SQL instruction, a table name or alias may be appended to the column name. For example, a column identified as a.emp_id may represent a column emp_id extracted or sourced from table a.

Sub-step d: AI engine 105 may generate areas of interest. Each area of interest may include at least a column name and a table name pair for each subquery. Based on the column and table name pair, AI engine 105 may determine a degree of relevance of the subject subquery to the user inquiry. Subqueries associated with a threshold degree of relevance may be determined to be relevant in responding to the user inquiry. AI engine 105 may be utilized to determine a degree of relevance. For example, AI engine 105 may determine whether a subquery is aligned or misaligned.

After locating and deconstructing relevant SQL instructions, AI engine 105 may employ cluster query validator 109 to validate the subqueries. Validating relevant SQL instructions may include inputting modified/sample values for columnar data referenced in each subquery. Validating relevant SQL instructions may include inputting modified/sample values for the columnar data in each area of interest.

When AI engine 105 determines that output generated in response to the modified/sample values is significantly different from output obtained from actual column data, validation is successful. When the output significantly changes in response to changing the input values, the subquery is having an impact on formulation of the resultant dataset. Therefore, the subquery is confirmed as being relevant to the user inquiry.

AI engine 105 may disregard subqueries or areas of interest that do not generate changes in output. When the output does not significantly change in response to changing the columnar input data, the subquery does not have an impact on formulation of the resultant dataset. Such subqueries may not be relevant to user inquiry.

After identifying a set of subqueries in the area of interest associated with the user inquiry, the subqueries in the set may be passed to NLP mapper 111. NLP mapper 111 may examine operators used within each subquery in the set. Based on the examined operators, NLP mapper 111 may generate, in natural language form, an explanation of the output generated by each subquery.

For example, when a subquery includes a SQL “where” operator, NLP mapper 111 may generate a natural language phrase that states “filters on <column name> if <value from ‘where clause’>”. Variables identified by “<variable name>” may be replaced by the operands of the subject subquery. NLP mapper 111 may replace other SQL operators such as =, >, <, != with corresponding natural language words such as “equal to”, “less than”, “greater than”, “not equal to.”

A subquery may include a “join” operator. NLP mapper 111 may convert a join operator of the subquery into a natural language phrase that states “joins on table <table_name> using column <column>”. A subquery may include a “left join” or “right join” operator. For a “left join” operator, NLP mapper 111 may generate a natural language phrase that states “joins on table <table_name_1> with <table_name_2> using <column>.” As another example, a subquery may include an “inner join” operator. For the “inner join” operator, NLP mapper 111 may generate a natural language phrase that states, “filters on <table_name> to fetch records based on column <column>.” NLP mapper 111 may replace variables <table_name> <column> with data extracted from one or more subqueries.

A subquery may include a “group by” operator. For the “group by” operator, NLP mapper 111 may generate a natural language phrase that states “groups by column name <column name>.” A subquery may include a “select” operator. For the “select” operator, NLP mapper 111 may generate a natural language phrase that states “displays or shows or fetches records from <table_name>.”

Flux profile analyzer 113 may join natural language descriptions obtained for each SQL operator and each subquery by NLP mapper 111 into a cohesive natural language description of relevant SQL instructions. The cohesive natural language description may provide a step-by-step explanation of how relevant SQL instructions generate the resultant dataset. Flux profile analyzer 113 may trigger transmission of the cohesive natural language description to User 101 that submitted a user inquiry via communication server 103. Flux profile analyzer 113 may transmit the cohesive natural language description to User 101 via email, chat or any suitable communication format.

Using AI described herein, apparatus and methods described in this disclosure may be adapted for use with a variety of SQL languages. A machine learning model constructed using the principles described herein may be trained to learn specific nuances unique to a specific SQL language. However, because SQL languages share common fundamental operators and functions, a single machine learning model may be utilized effectively.

For example, AI engine 105 may detect that relevant SQL instructions or a subquery include unknown keywords. In response to detecting the unknown keywords, AI engine 105 may trigger a retraining of machine learning models utilized to identify SQL operators. AI engine 105 may trigger a training of machine learning models it utilizes to generate a natural language description of SQL operators. As a result of sharing common core operators, by retraining, machine learning models may be adaptable to identify and formulate natural language descriptions of newly identified keywords.

System 100 may be successfully deployed in connection different databases that each may use variant SQL instructions. Approximately 90% of any SQL instructions will be the same. Machine learning algorithms may “learn” to account for the 10% difference when testing different SQL instructions. Additional, user login information detected by communication server 103 may identify which database system and associated SQL instructions are being used by user 101.

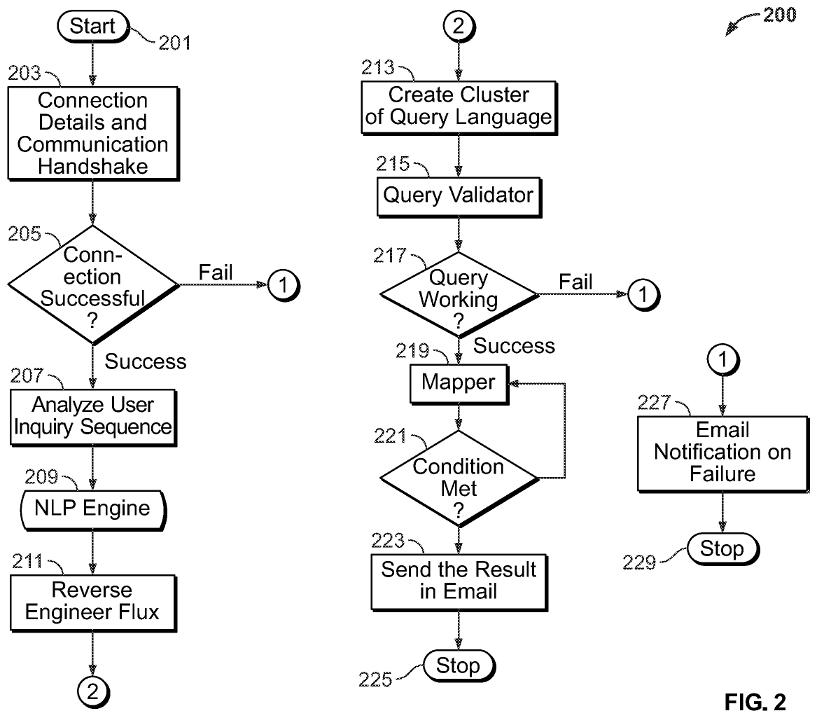

FIG. 2 shows illustrative process 200. Process 200 may be executed by a computer system. For the sake of illustration, one or more of the steps of process 200 will be described as being performed by a “system.” The “system” may include the computational tools of system 100 (shown in FIG. 1) and may include one or more components of any other suitable computer system.

Process 200 begins with User 101 submitting a user inquiry at step 201. At step 203, connection details and a communication handshake are established with a data repository system, such as repository 115 (shown in FIG. 1). Such a system may be a data warehouse system for “big data” management such as a Hadoop server. The data repository system provides access to SQL instructions that are executed to product a resultant dataset. The data repository may provide access to underlying information that is extracted from a data lake or other repository to formulate the resultant dataset.

At step 205, if the attempt to establish a connection to the data depository fails, the process proceeds to step 227. At step 227, an email notification is transmitted to requesting user 101 informing user 101 of the connection failure. In this scenario, process 200 terminates at step 229. At step 205, if the attempt to establish a connection to the data depository succeeds, the process continues on to step 207.

Analysis at step 207 may include utilizing AI engine 105 to determine relevant SQL instructions based on the submitted user inquiry. Step 207 may include identifying keywords within the user inquiry. Step 207 may include locating one or more relevant SQL instructions. Relevant SQL instructions may include one or more sets of SQL instructions that generate the resultant dataset. AI engine 105 may extract keywords from the user inquiry.

At step 209, based on the keywords identified in step 207, the system may identify one or more “areas of interest.” Areas of interest may include a resultant dataset that is the subject of the user inquiry. Areas of interest may include a column or table name that contains data used to formulate the resultant dataset. The areas of interest may be utilized by the system to locate the resultant dataset and relevant SQL inquires that generate the resultant dataset. Step 209 may include using keywords identified by AI engine 105 at step 207 to locate relevant SQL instructions stored in the data repository.

At step 211, the system may attempt to reverse engineer a SQL flux or logic/process flow associated with the identified relevant SQL instructions. Step 211 may include deconstructing the relevant SQL instructions into subqueries. Step 211 may include generating fₙ and gₙ markers for the relevant SQL instructions. Step 211 may include mapping fₙ and gₙ markers by order of increasing values of fₙ to decreasing values of gₙ.

At step 213, the system creates “clusters” of data inputs utilized by the relevant SQL instructions to generate the resultant dataset. The system may create the clusters by computing areas of interest associated with subqueries identified at step 211 and included in the relevant SQL instructions. The system may create the clusters by grouping column/row names into categories using NLP concepts such as Levenshtein distance and/or word tokenization. A cluster may include a pair of column names and table names for each subquery. The clusters may be created based on sub-steps a-d described above.

At step 215, the system validates subqueries included in a relevant SQL instruction. The system may validate subqueries associated with a threshold cluster level or threshold degree of relevance determined based on the clustering of step 213. Step 215 may include providing modified/sample values for the columnar data for clustered subqueries. If output obtained in response to the modified/sample values alters the output generated by each subquery, the validation is successful.

The system may ignore columns which do not generate changes in output in response to the modified/sample values. Ignoring columns may reduce computation power and processing time for the system running process 200. Data in the ignored columns may not be checked for errors, which requires substantial computational power and processing time.

At step 217, the system validates subqueries included in a relevant SQL instruction. Validation may include “mapping” conditions of a subquery in accordance with steps 1-9 described above. Validation may include testing whether subqueries generate expected resultant datasets in response to known test values. At step 217, invalid or inoperable subqueries trigger an error message at step 227 and termination of process 200 at step 229. An inoperable subquery may indicate a flaw in a relevant SQL instruction.

At step 219 the system generates a natural language explanation of the actions taken by a subquery included in a relevant SQL instruction. Step 221 shows the system may operate recursively to link natural language explanations of two or more subqueries.

Linking the explanation generated for two or more subqueries may provide a step-by-step explanation of how a relevant SQL instructions operates to generate a resultant dataset identified in the user inquiry. At step 223, the system transmits the step-by-step explanation to a user that submitted the user inquiry. Process 200 terminates at step 225.

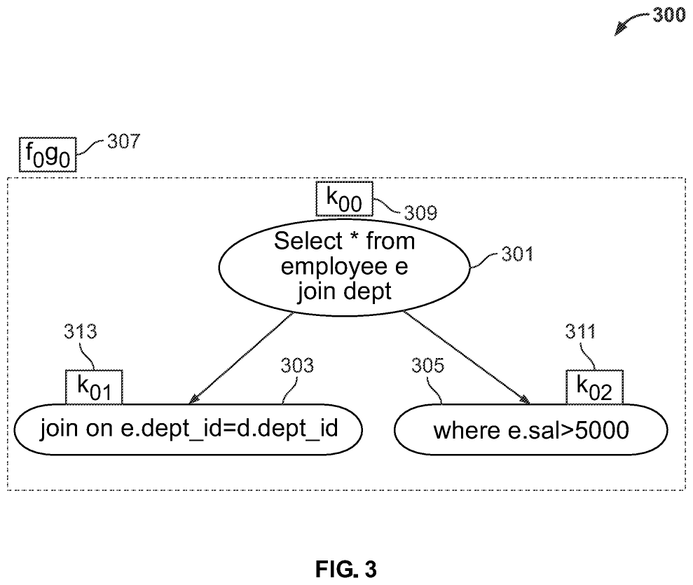

FIG. 3 shows illustrative results for an exemplary use case generated by system 100 and/or process 200. An exemplary user inquiry may include the following natural language question:
“Why am I not seeing employee data with salary less than 5000 in the report—emp_sal?” Ex. 1

In response to receiving the user inquiry of Ex. 1, NLP techniques are applied to extract keywords from the user inquiry. For Ex. 1, the following keywords may be generated:
employee, salary, 5000, emp_sal Ex. 2

Based on the extracted keywords of Ex. 2, relevant SQL instructions are located and extracted from one or more data repositories. Relevant SQL instructions may be identified based on whether a SQL instruction includes or operates on one or more of the extracted keywords. For the user inquiry of Ex. 1, an illustrative relevant SQL instruction may include the following:
Select * from employee e join dept d on e. dept_id=d.dept_id where e.sal>5000 Ex. 3

A relevant SQL instruction may be deconstructed into subqueries. Deconstructing the relevant SQL instruction into subqueries may include scanning the relevant SQL instructions for a first keyword. An illustrative keyword may include the first “from” keyword in a relevant SQL instruction. In the family of SQL languages, the word after “from” is typically a driver table for the SQL instruction. For the relevant SQL instruction of Ex. 3, the driver table is employee e.

Next, each opening parenthesis “(” in a relevant SQL instructions is marked with an identifier fₙ, where n represents the n^{th} occurrence of an opening parenthesis within the relevant SQL instruction. Each closing parenthesis “)” in the relevant SQL instructions is marked with an identifier gₙ where n represents the n^{th} occurrence of a closing parenthesis within the relevant SQL instruction.

Each instance of fₙ is mapped to a corresponding instance of gₙ. Because the relevant SQL instruction of Ex. 3 does not include any parenthesis, there will only be one mapping, f₀g₀, as shown at 307 in FIG. 3.

Next, keywords such as “join,” “where,” or “group by” are detected within the relevant SQL instruction of Ex. 3. Each detected keyword may be assigned an identifier K_{n,i} where n is the fₙ mapping number and i is the i^{th} occurrence of a detected keyword. FIG. 3 shows how SQL instruction Ex. 3 has been deconstructed into three subqueries. One associated with identifier K_{0,0} (at 309 in FIG. 3), a second associated with identifier K_{0,1} (at 313 in FIG. 3) and a third associated with identifier K_{0,2} (at 311 in FIG. 3). Each K_{n,i} identifier may represent an independent subquery associated with relevant SQL instructions of Ex. 3. FIG. 3 shows that the relevant SQL instruction of Ex. 3 has been deconstructed into subqueries 301, 303 and 305.

After generating the subqueries, the subqueries are converted into natural language terminology. Subquery 301 may be converted into the following natural language terminology: Fetches all columns from tables {employee} and {dept}. Subquery 303 may be converted into the following natural language terminology: Table {employee} is joined with table {dept} on column {dept id}. Subquery 305 may be converted into the following natural language terminology: Filters on column {salary} from table {employee} if value is greater than 5000.

As discussed above, one of the keywords shown in Ex. 2 is employee. This keyword may be associated with more than one relevant SQL instruction. For example, in addition to the relevant SQL instruction identified above in Ex. 3, the keyword employee may also be associated with the following relevant SQL instruction: Select a.emp_id, a.dept_name, a.salary from (select e.emp_id, e.emp_name, max(e.salary), d.dept_name from employee e join dept d on e.dept_id=d.dept_id group by d.dept_name) a Ex. 4

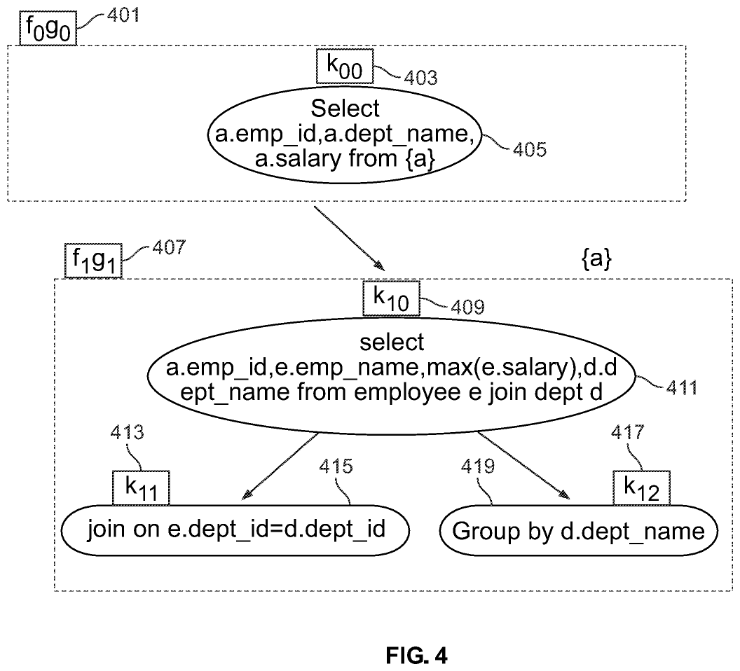

As shown in FIG. 4, the relevant SQL instruction of Ex. 4 may be deconstructed into subqueries 405, 411, 415 and 419. Deconstructing the relevant SQL instruction of Ex. 4 into subqueries may include scanning the relevant SQL instructions of Ex. 4 for a first keyword. An illustrative keyword may include the first “from” keyword in the SQL instructions. In the family of SQL languages, the word after “from” is typically a driver table for the SQL instruction. For the relevant SQL instruction of Ex. 4, the driver table is itself a nested SQL instruction:
from select e.emp_id, e.emp_name, max (e.salary), d.dept_name from employee e join dept d.

In FIG. 4, this nested SQL instruction is represented by {a} in subquery 405 and is shown in subquery 411. Next, each opening parenthesis “(” in the relevant SQL instruction of Ex. 4 is marked with an identifier fₙ, where n represents the n^{th} occurrence of an opening parenthesis within the relevant SQL instruction. Each closing parenthesis “)” in the relevant SQL instructions of Ex. 4 is also marked with an identifier gₙ where n represents the n^{th} occurrence of a closing parenthesis within the relevant SQL instructions.

Each instance of fₙ is mapped to a corresponding instance of gₙ. FIG. 4 shows that the relevant SQL instruction of Ex. 4 is associated with mappings f₀g₀ (at 401 in FIG. 4) and f₁g₁ (at 407 in FIG. 4). Mapping 401 corresponds to a first segment of the SQL instruction (outside parenthesis) and mapping 407 corresponds to a second segment of the SQL instruction (inside parenthesis).

Next, keywords such as “join,” “where,” or “group by” are detected within the relevant SQL instruction of Ex. 4. Each detected keyword may be assigned an identifier K_{n,i} where n is the fₙ mapping number and i is the i^{th} occurrence of the detected keyword. FIG. 4 shows how SQL instruction Ex. 4 has been deconstructed into segments associated with identifier K_{0,0} (at 403 in FIG. 4) , K_{1,0} (at 409 in FIG. 4) , K_{1,1} (at 413 in FIG. 4) and K_{1,2} (at 417 in FIG. 4).

Each identifier may represent an independent subquery associated with relevant SQL instructions of Ex. 4. FIG. 4 shows that the relevant SQL instruction of Ex. 4 has been deconstructed into subqueries 405, 411, 415 and 419. After generating the subqueries, the subqueries are converted into natural language terminology. Subquery 405 may be converted into the following natural language terminology: Shows employee id, department name, salary from subquery {a}. Subquery 411 (represented by {a} in subquery 405) may be converted into the following natural language terminology:
Shows employee id, employee name, maximum salary, dept name from tables {employee} and {dept}

Subquery 415 may be converted into the following natural language terminology: Table {employee} is joined with table {dept} on column {dept id}. Subquery 419 may be converted into the following natural language terminology: Groups by column {dept_name} from table {dept}.

AI engine 105 may analyze the fₙgₙ and K_{n,i} mappings associated with the relevant SQL instruction of Ex. 4 and attempt to locate “areas of interest.” Areas of interest may represent subqueries likely to be relevant to a question raised in the user inquiry of Ex. 1.

Out of the areas of interest and extracted keywords (shown in Ex. 2) identified in the user inquiry in Ex. 1, AI engine 105 may filter or generate a natural language phrase to send as response to the user inquiry. For example, AI engine 105 may ignore the relevant SQL instruction of Ex. 4. In some embodiments, AI engine 105 may recognize that the relevant SQL instruction of Ex. 3 includes an operation that answers the user inquiry of Ex. 1. In such embodiments, AI engine 105 may not spend computing processing resources or time deconstructing the relevant SQL instruction of Ex. 4.

AI engine 105 may determine that the relevant SQL instruction of Ex. 3 provides an explanation to the question raised in user inquiry of Ex 1. For the identified SQL instructions (shown in Ex. 3 and Ex. 4) deemed relevant to the user inquiry of Ex. 1, AI engine 105 may formulate the following natural language response based on the natural language formulations of subqueries 301, 303 and 305:
The sql-employee_f filter.sql filters on column {salary} from table {employee} if value is greater than 5000.

The formulated natural language response is then transmitted to the user that submitted the user inquiry of Ex. 1 or displayed in a graphical user interface.

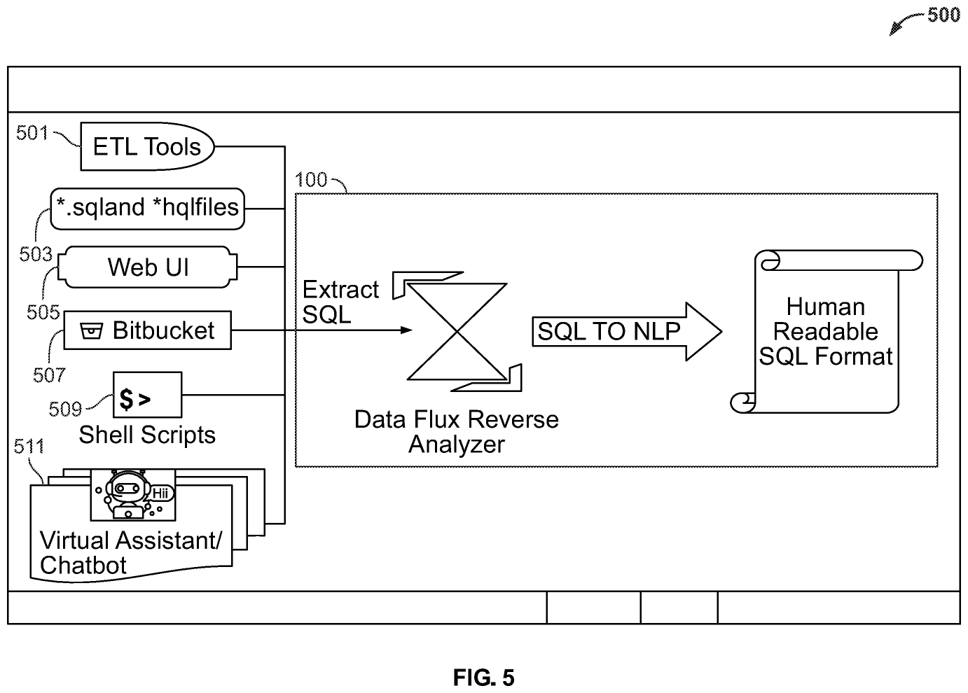

FIG. 5 shows illustrative system 500. System 500 shows that system 100 (described above in FIG. 1) may successfully extract relevant SQL instructions from a variety of sub-systems that utilize SQL logic and instructions. For example, FIG. 5 shows that SQL instructions may be extracted from ETL tools 501. SQL instructions may be extracted from Apache HiveQL scripts 503 associated with Hadoop database systems. SQL instructions may be extracted from web user interface 505. SQL instructions may be extracted from source code repositories 507 such as Bitbucket. SQL instructions may be extracted from shell scripts 509. SQL instructions may be extracted from chatbot programs 511.

Thus, apparatus and methods for VERSATILE QUERY LOGIC ON DATA FLUX REVERSE ANALYZER have been provided. Persons skilled in the art will appreciate that the present disclosure can be practiced by other than the described embodiments, which are presented for purposes of illustration rather than of limitation. The present disclosure is limited only by the claims that follow.

What is claimed is:

1. An artificial intelligence (“AI”) detector of a data abnormality in a resultant dataset generated by a SQL query executed in a high-volume computer system, the AI detector comprising:
a computer processor; and
one or more non-transitory computer-readable media storing computer executable instructions, that when executed by the computer processor:
ingest, in natural language form, a user inquiry regarding output generated by the high-volume computer system;
extract the resultant dataset from the user inquiry;
establish a logical link between the resultant dataset and a target SQL query;
deconstruct the target SQL query into a plurality of subqueries;
validate that each subquery impacts formulation of the resultant dataset;
create a set of subqueries wherein, each member of the set of subqueries impacts formulation of the resultant dataset;
convert each member of the set of subqueries into natural language form;
apply a natural language processing algorithm and detect terms associated with a threshold degree of overlapping interest shared by the natural language form of each member of the set of subqueries and the user inquiry;
determine whether the terms associated with the threshold degree of overlapping interest are aligned or misaligned with the user inquiry; and
for each misaligned term, locate a corresponding SQL subquery and reformulate the corresponding SQL subquery so that it is aligned with the user inquiry.

2. The AI detector of claim 1 wherein the natural language processing algorithm utilizes a Levenshtein distance algorithm to detect the terms associated with the threshold degree of overlapping interest.

3. The AI detector of claim 1 wherein the natural language processing algorithm utilizes word tokenization to detect the terms associated with the threshold degree of overlapping interest.

4. The AI detector of claim 1 the computer executable instructions, when executed by the computer processor generates a step-by-step natural language explanation of how the target SQL query generates the resultant dataset.

5. An artificial intelligence (“AI”) method for responding to a user inquiry regarding a resultant dataset that is machine-generated by a programmed SQL operational string executed against a data lake, the method comprising:
ingesting the user inquiry in a natural language form;
parsing the user inquiry in the natural language form and extracting a reference to the resultant dataset from within the user inquiry;
pinpointing a target SQL query that operates on the reference;
mapping a natural language contextual description of the reference in the user inquiry to a target SQL operator within the target SQL query;
recursively deconstructing the target SQL query into a plurality of subqueries;
generating a natural language form for each subquery;
applying a machine learning filter that identifies a target subquery that links the resultant dataset and the target SQL operator;
formulating a machine generated, natural language response to the user inquiry using the natural language form of the target subquery that links the resultant dataset and the target SQL operator; and
when the machine learning filter fails to identify the target subquery, triggering automated testing of each of the plurality of subqueries.

6. The AI method of claim 5, further comprising:
formulating a machine-generated alternative SQL query that is responsive to the user inquiry; and
triggering automated testing of the machine-generated alternative SQL query to verify that it is responsive to the user inquiry.

7. The AI method of claim 6 further comprising, formulating a machine generated, natural language response to the user inquiry based on the machine-generated alternative SQL query.

8. The AI method of claim 5 wherein, the machine-generated, natural language response to the user inquiry explains, in natural language, why operation of the target subquery generates the resultant dataset.

9. The AI method of claim 5, wherein each of the plurality of subqueries include the target SQL operator and at least one driver table that is input to the target SQL operator.

10. The AI method of claim 9, wherein data from the at least one driver table is included the resultant dataset.

11. The AI method of claim 5, wherein the programmed SQL operational string executes an extraction, transfer load (“ETL”) procedure.

12. The AI method of claim 5, wherein the reference to the resultant dataset identified in the user inquiry is determined based on establishing a logical link between a natural language term in the user inquiry and a machine understandable term in the target SQL query.

13. An artificial intelligence (“AI”) detector of a data abnormality in output generated by a SQL query executed in a high-volume computer system, the AI detector comprising:
a computer processor; and
one or more non-transitory computer-readable media storing computer executable instructions, that when executed by the computer processor:
ingest, in natural language form, a user inquiry regarding output generated by the high-volume computer system;
extract a resultant dataset from the user inquiry;
establish a logical link between the resultant dataset and a target SQL query;
deconstruct the target SQL query into a plurality of subqueries, each subquery being executable as a stand-alone SQL query;
validate that each of the plurality of subqueries impacts formulation of the resultant dataset;
create a set of subqueries wherein, each member of the set of subqueries impacts formulation of the resultant dataset;
using the set of subqueries, construct a resultant SQL query that, when executed by the high-volume computer system, formulates the resultant dataset;
extract, from the user inquiry, a contextual description of the resultant dataset that maps onto a target SQL operator;
determine whether the resultant SQL query includes the target SQL operator;
convert each subquery within the resultant SQL query that includes the target SQL operator into natural language form; and
construct a natural language response to the user inquiry using the subqueries within the resultant SQL query that have been converted into natural language form.

14. The AI detector of claim 13, the computer executable instructions, when executed by the computer processor:
determine whether the resultant SQL query includes a variant SQL operator that is functionally equivalent to the target SQL operator; and
convert each subquery within the resultant SQL query that includes the variant SQL operator into natural language form.

15. The AI detector of claim 13, wherein each subquery converted into natural language form is executable as a stand-alone SQL query, wherein the stand-alone SQL query comprises a SQL operator and operand pair.

16. The AI detector of claim 13, the computer executable instructions, when executed by the computer processor validate that each subquery that includes the target SQL operator impacts formulation of the resultant dataset by changing at least one SQL operator included in each subquery and determining whether, after the changing, the resultant SQL query generates the resultant dataset.

17. The AI detector of claim 13, the computer executable instructions, when executed by the computer processor trigger an automated retraining of a machine learning model when the AI detector is unable to extract the contextual description of the resultant dataset that maps onto the target SQL operator.

18. The AI detector of claim 13, the computer executable instructions, when executed by the computer processor trigger an automated retraining of a machine learning model that maps one or more SQL operands into natural language phrases when the AI detector is unable to identify the resultant dataset in the user inquiry.

19. The AI detector of claim 13, the computer executable instructions, when executed by the computer processor locate multiple target SQL queries and deconstructs each of the target SQL queries.

20. The AI detector of claim 13, the computer executable instructions, when executed by the computer processor validates that each subquery impacts formulation of the resultant dataset by:
providing modified values for at least one data column referenced in each subquery that includes the target SQL operator;
in response to detecting that execution of the target SQL query based on the modified values alters the resultant dataset, register a corresponding subquery as impacting formulation of the resultant dataset; and
in response to detecting that execution of the target SQL query based on the modified values does not alter the resultant dataset, ignore the corresponding subquery.
